(19) United States
(12) Patent Application Publication
(10) Pub. No.: US 2009/0130626 A1
(43) Pub. Date: May 21, 2009

(54) ORAL MEASURING SYSTEM

(76) Inventor: MARINUS JOHANNES PETRUS VETJENS, Helmond (NL)

Correspondence Address: LAW OFFICES OF ERIC KARICH, 2807 ST. MARK DR., MANSFIELD, TX, 76063, US

(21) Appl. No.: 12/063,491

(22) PCT Filed: Aug. 10, 2006
(86) PCT No.: PCT/NL2006/000416

§ 371 Date: Feb. 11, 2008

(30) Foreign Application Priority Data
Aug. 10, 2005 (NL) 1029711

(51) Int. Cl. A61C 19/04

(52) U.S. Cl. 433/68

(57) ABSTRACT

An oral measuring system has a recording unit provided with a picture sensor, and an interface. The interface, connected to the recording unit, includes a light-conducting Bauernfeind prism that is provided with a recording surface and a picture surface. The recording surface during use is brought into the vicinity of and/or in contact with one of the above sides of a set of teeth to be measured or into an oral cavity, and which picture surface is connected to the recording unit.

### BACKGROUND OF THE INVENTION

1. Field of the Invention

The invention relates to an oral measuring system for taking a picture of a set of teeth or an oral cavity to be measured, which set of teeth has an occlusal side as well as a front and two lateral sides, and where there are gaps at the point of contact between two neighbouring teeth, which oral measuring system comprises a recording unit provided with a picture sensor, as well as an interface that is connected to the recording unit and which comprises a light-conducting prism that is provided with a recording surface and a picture surface, which recording surface is brought during use into the vicinity of and/or in contact with one of the above sides of a set of teeth to be measured or in an oral cavity to be measured, and which picture surface is connected to the recording unit.

2. Description of Related Art

A prior art oral measuring system is disclosed European patent application EP-A-0 250 992. In this oral measuring system, the prism has an elongated form and acts as mirror tilted at 45 degrees with a connected light-conducting element. As the first light-reflecting surface on which the incoming picture is reflected is at 45 degrees and the dimensions of this surface are limited, as the prism must be held in the mouth when a picture is being taken, this known oral measuring system can only take a picture of a small part of the set of teeth or the oral cavity.

### SUMMARY OF THE INVENTION

An oral measuring system has a recording unit provided with a picture sensor, and an interface. The interface, connected to the recording unit, includes a light-conducting Bauernfeind prism that is provided with a recording surface and a picture surface. The recording surface during use is brought into the vicinity of and/or in contact with one of the above sides of a set of teeth to be measured or into an oral cavity, and which picture surface is connected to the recording unit.

Various embodiments of the present invention may be devised by those skilled in the art.

The oral measuring system may enable a whole side of a set of teeth or oral cavity to be photographed in one operation. For this purpose, the oral measuring system according to the invention is characterized in that the prism is a Bauernfeind prism, in which a first light-reflecting surface may be tilted at an angle of less than 45 degrees so that with such a prism with a low height a picture of a whole side of the set of teeth or of the whole oral cavity can still be taken. In one embodiment, the recording surface is at least virtually just as large as one of the above sides of the set of teeth.

In one embodiment, the angles of the lengthwise cross-section of the prism are respectively 22-32, 49-59 and 95-105 degrees. In one form of the prism the angles of the lengthwise cross-section of the prism are respectively 27, 54 and 99 degrees, although variations may be made by one skilled in the art, and such variations should be considered within the scope of the present invention.

Moreover the lengths of the sides of the lengthwise cross-section of the prism may be respectively 40-50, 76-86 and 94-104 millimetres. In one form of the prism, the lengths of the sides of the lengthwise cross-section of the prism are respectively 45.5, 81 and 98.9 millimetres.

An embodiment of the oral measuring system according to the invention is characterized in that the form of the prism is such that little or no reflections of the contours of the picture surface are visible on the recording surface. The reflections of the contours of the picture surface on a surface in which the recording surface is found in this embodiment therefore fall outside the bordering edges of the recording surface. This means that there are no inconvenient reflections in the picture taken, which would negatively influence the quality of the picture.

A further embodiment of the oral measuring system according to the invention is characterized in that there is an anti-reflection coating on the picture surface and the recording surface.

To prevent damage (scratches) to the recording surface of the prism a protective plate may be present in front of the recording surface, which has an anti-reflection coating on both sides.

Still a further embodiment of the oral measuring system according to the invention is characterized in that the oral measuring system also comprises a removable protective cover, which is placed over the prism and at least protects the contact side, which protective cover has an anti-reflection coating on both sides and/or has a provision to prevent condensation on the outside.

In order to aim the interface easily with respect to a set of teeth or oral cavity so that a reproducible picture can be taken, an embodiment of the oral measuring system according to the invention is characterized in that the recording surface of the interface is provided with at least one optical mark. Preferably there is more than one mark on the recording surface. The marks can for example be formed by points or small circles. After placing the interface on or against a set of teeth or in an oral cavity, the interface can be pushed or turned until the marks are in a certain position with respect to the set of teeth or oral cavity.

In order to compare the pictures taken better and more quickly with each other a further embodiment of the oral measuring system is characterized in that the interface on or near the recording surface is provided with at least one protrusion, which during use comes into contact with a part of at least one of the above sides of the set of teeth to be measured or comes into at least one of the above gaps between two neighbouring teeth. A part of the set of teeth is used here as the reference so that the interface can be inserted simply and reproducibly with respect to the set of teeth using the protrusion. The pictures taken can thus be compared directly with each other and do not first have to be aligned with respect to each other.

Preferably during use the protrusion comes against the teeth that border the gap in the middle of the front of the set of teeth.

Again a further embodiment of the oral measuring system according to the invention is characterized in that the interface is provided with at least two protrusions, which are present on the recording surface of the prism or, on the condition that the interface comprises more than one prism, on the recording surfaces of at least two prisms. Using two or more protrusions the interface can be positioned more easily and reproducibly with respect to a set of teeth.

Moreover preferably one of the protrusions is present on the recording surface so that during use it comes against a part of the lateral side of the set of teeth to be measured.

Still a further embodiment of the oral measuring system according to the invention is characterized in that the interface comprises four Bauernfeind prisms, in which the recording surfaces are present with respect to each other so that one recording surface during use is against or near the occlusal side of the set of teeth to be measured, one recording surface is against or near the front of the set of teeth, and two recording surfaces are against or near the lateral sides of the set of teeth. In this way a picture can be taken in one measurement of the occlusal side and the outsides of the top or lower teeth. If a recording surface is placed against the occlusal side of the set of teeth, this recording surface forms a reference surface for positioning the interface.

In order to take a clearer picture of the set of teeth or the oral cavity preferably at least one of the light-reflecting surfaces of the Bauernfeind prism is provided with a reflecting coating.

Moreover the recording unit preferably comprises a display. This means that when positioning the interface it can be aligned with respect to the set of teeth or the oral cavity and moreover a first impression can be obtained of the set of teeth or the oral cavity.

In a further embodiment the recording unit is provided with a UV light source. The light-conducting element (prism) is in this case preferably made of a UV transparent plastic, such as PMMA. If radiated with (invisible) UV light, the tooth enamel, the dentine and the organic films present emit visible light of different colours and intensities (fluorescent light). The fluorescent effect enables the condition of the set of teeth or the oral cavity to be deduced from the colour and intensity differences in the picture taken, such as for example the extent of wear and the presence of dental plaque and bacteria.

In another embodiment, or in combination with the previous one, the recording unit is provided with an IR light source. Depending on the wavelength, the dental tissue is IR transparent or has specific absorption peaks that match the absorption of collagens (organic substances), hydroxyapatite (minerals) and bacterial proteins. Analysis of the absorption picture and the transmission picture through the teeth (for the latter the oral measuring system must be made so that the light source and the recording unit are present on both sides of the teeth) enables the condition of the set of teeth, such as for example the degree of calcification and presence of caries, to be deduced, or respectively a picture can be obtained of the inside of the teeth and the surrounding gums.

Preferably the UV and/or IR light source is present opposite the picture surface of the prism.

To obtain a photograph of the set of teeth or the oral cavity the recording unit preferably comprises a light source, which can emit white light.

Preferably the white light source is opposite one of the sides of the prism.

The recording unit preferably comprises illuminating devices, which are made so that they can illuminate the set of teeth or oral cavity to be measured continually or for a short time. The continual illumination can for example be used during the positioning of the interface against a set of teeth or in an oral cavity and the brighter, short-term illumination can be used when taking a picture of the set of teeth or oral cavity. Short-term illumination with a high intensity is necessary to generate fluorescence.

The recording unit is preferably detachable from the interface. This means that different interfaces, for example for adults and for babies, can be connected to the recording unit so that a different recording unit is not needed for every interface.

The invention also relates to an interface that can be used in the oral measuring system according to the invention.

### BRIEF DESCRIPTION OF THE DRAWINGS

The invention will be elucidated more fully below on the basis of drawings in which an embodiment of the oral measuring system according to the invention is shown. In these drawings:

FIG. 1 shows a bottom elevation of a first embodiment of the oral measuring system according to the invention for the measurement of an occlusal side of a top or bottom set of teeth;

FIG. 2 shows a side elevation of the oral measuring system shown in FIG. 1;

FIG. 3 shows a bottom elevation of an interface of a second embodiment of the oral measuring system according to the invention for the measurement of the outside and an occlusal side of a top or bottom set of teeth;

FIG. 4 shows a side elevation of the interface shown in FIG. 3; and

FIG. 5 shows an embodiment of a cover, which can be placed over an interface to promote hygiene.

### DETAILED DESCRIPTION OF THE INVENTION

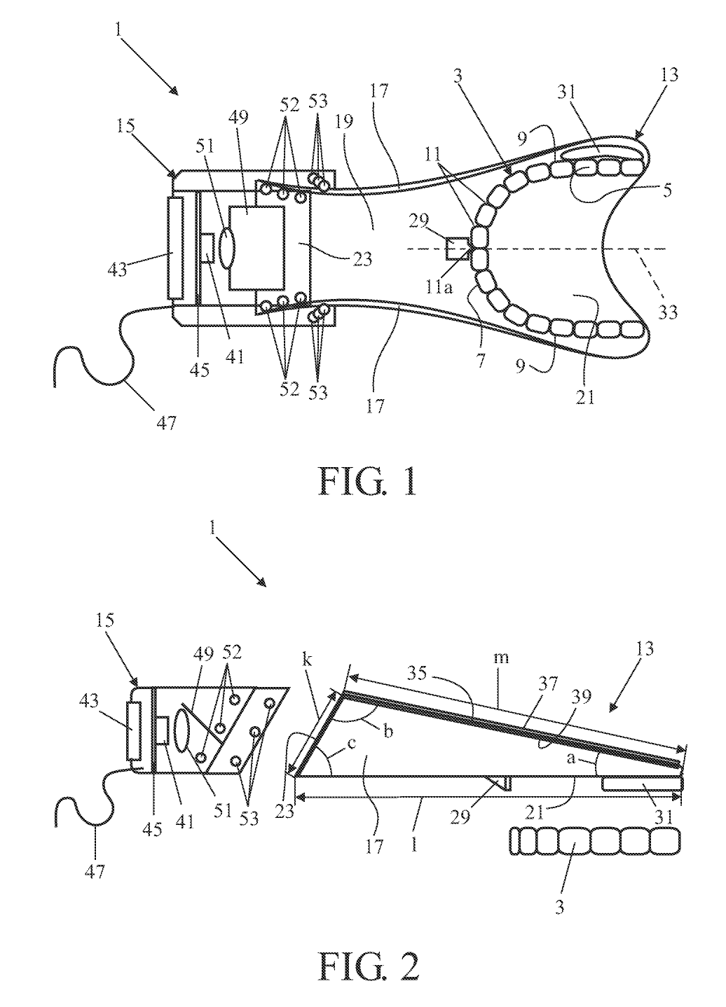

FIGS. 1 and 2 show a bottom and side elevation respectively of a first embodiment of the oral measuring system 1 according to the invention. The set of teeth to be measured 3 has an occlusal side 5, a front 7 and two lateral sides 9, in which there are gaps 11 at the point of contact between two neighbouring teeth. This oral measuring system 1 is used to measure an occlusal side 5 of a top or bottom set of teeth 3 and comprises an interface 13 and a recording unit 15, which can be detached from the interface, for example by using a sliding insert connection.

The interface 13 has a Bauernfeind prism 19 of which a part of a surface forms a recording surface 21 and another surface forms a picture surface 23. The recording surface 21 during use is present against the occlusal side 5 of the set of teeth 3 and the picture surface 23 is connected to the recording unit 15. There is an anti-reflection coating on the recording surface 21 and the picture surface 23.

The angles a, b and c of the lengthwise cross-section or side elevation of the prism are respectively 27±0.1, 54 and 99±0.1 degrees and the lengths k, l and m of the sides of the lengthwise cross-section or the side elevation of the prism are respectively 45.45, 81 and 98.89 millimetres.

To prevent damage to the recording surface 21, a protective plate (not shown), which is provided with an anti-reflection coating on both sides, can be placed in front of the recording surface.

There are two protrusions 29, 31 on the recording surface 21 of the interface 13 of which a first 29 is on the median 33 of the prism 19 and the second 31 is near the extremity and the side of the prism. During use the first protrusion is present in the gap 11a between the median surface 33 of the set of teeth 3 and the second protrusion 31 is in contact with a part of one of the lateral sides 9 of the set of teeth to be measured.

One of the surfaces 35 of the prism acts as a light-reflecting surface and is provided with a reflecting coating 37 and is covered by a protective coating 39.

The recording unit 15 has a picture recorder 41 in the form of a CCD or CMOS chip, a display 43, and connected electronics 45, which can be connected via a data cable 47 to an external apparatus, for example a computer. The recording unit 15 also has a semi-transparent mirror 49, a lens 51, UV light sources 52 and white light sources 53, in which the light sources 52, 53 are made so that they can illuminate the set of teeth to be measured continually or for a short time. The UV light sources are opposite the picture surface 23 of the prism and the white light sources are opposite the sides 17 of the prism. Both light sources have a provision for the stabilisation of the light intensity.

The recording unit 15 on illumination by the light sources 52, 53 works with both short and long wavelengths of light from the far ultraviolet to the far infrared and with all visible wavelengths.

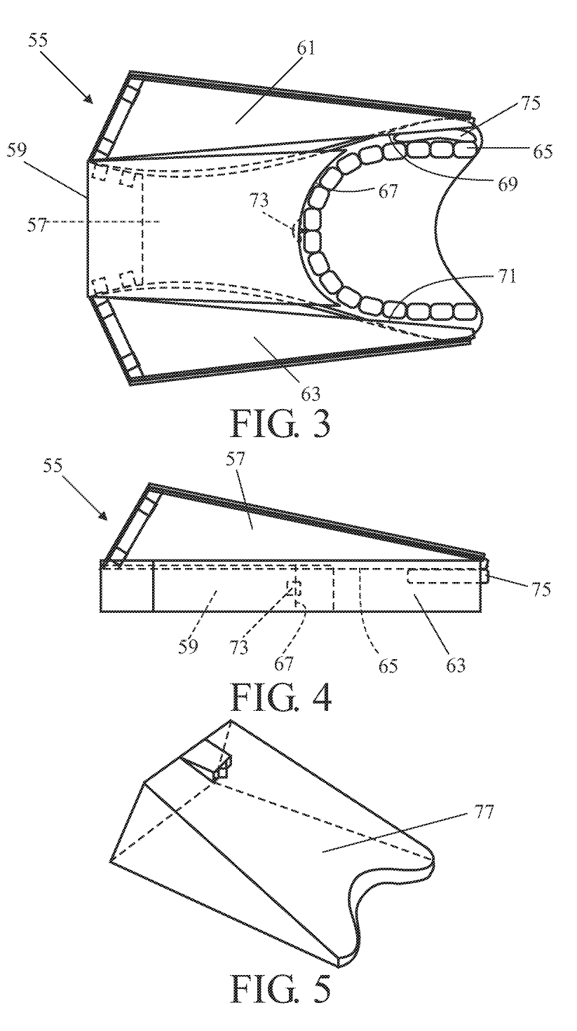

FIGS. 3 and 4 show bottom and side elevations respectively of an interface 55 of a second embodiment of the oral measuring system according to the invention. This oral measuring system is used to measure the outside (i.e. the front and both lateral sides) and an occlusal side of a top or bottom set of teeth and also comprises an interface 55 and a detachable recording unit.

Contrary to the first embodiment, this interface 55 has four prisms 57-63, one for the occlusal side, which is equal to the prism of the first embodiment, one for the front of the set of teeth and two for the lateral sides of the set of teeth. Moreover the recording unit consists of four parts (not shown), which are each connected to a prism.

The recording surface 65 of the prism 57 during use is positioned against the occlusal side of the set of teeth to be measured 65, the recording surface 67 of the prism 59 is near the front of the set of teeth, and the recording surfaces 69 and 71 of the prisms 61 and 63 are near the lateral sides of the set of teeth.

This interface 55 also has two protrusions 73 and 75. One of the protrusions 73 is on the recording surface 67 of prism 59 and the other protrusion 75 is on the recording surface 65 of the prism 57.

To promote hygiene the oral measuring system has a transparent protective cover 77, which can be placed over the interface, see FIG. 5. The protective cover 77 is for example made of plastic or rubber and fits closely over the interface. Preferably the protective cover 77 is somewhat smaller than the interface so that it must be slightly stretched when it is placed over and then clings to the interface. FIG. 5 shows the protective cover 77 for an occlusal set of teeth interface with the bottom upwards. The bottom is here the side that is placed over the recording surface of the prism.

This protective cover 77 is suitable to be placed over the part on the free extremity of a prism, which is equal to the prism 19 shown in FIGS. 1 and 2, but then without protrusion 31 but with protrusion 29. The protective cover 77 for this purpose is provided with a protruding part that can be placed over the protrusion 29 present on the recording surface.

The protective cover 77 is provided on both sides with an anti-reflection coating and moreover is provided on the outside with an anti-condensation coating.

Instead of protective covers 77, which can be cleaned after use or can be disposed of, a temporary layer can also be applied to the interface, for example by dipping the interface in a liquid, for example liquid PMMA, so that a layer of the liquid adheres to the interface and hardens to a transparent layer.

Although in the above the invention is explained on the basis of the drawings, it should be noted that the invention is in no way limited to the embodiments shown in the drawings. The invention also extends to all embodiments deviating from the embodiments shown in the drawings within the context defined by the claims. As stated in the introduction the oral measuring system can also be used for taking a picture of an oral cavity instead of a set of teeth.

What is claimed is:

1. Oral measuring system for taking a picture of a set of teeth or an oral cavity to be measured, which set of teeth has an occlusal side as well as a front and two lateral sides, in which there are gaps at the point of contact between two neighbouring teeth, the oral measuring system comprising:
a recording unit provided with a picture sensor;
an interface connected to the recording unit and which comprises a light-conducting prism that is provided with a recording surface and a picture surface, which recording surface during use is brought into the vicinity of and/or in contact with one of the above sides of a set of teeth to be measured or into an oral cavity, and which picture surface is connected to the recording unit; and
wherein the prism is a Bauernfeind prism.

2. Oral measuring system according to claim 1, wherein angles of a lengthwise cross-section of the prism are respectively 22-32, 49-59, and 95-105 degrees.

3. Oral measuring system according to claim 1, wherein angles of the lengthwise cross-section of the prism are respectively 27, 54, and 99 degrees.

4. Oral measuring system according to claim 1, wherein lengths of sides of a lengthwise cross-section of the prism are respectively 40-50, 76-86, and 94-104 millimetres.

5. Oral measuring system according to claim 1, wherein lengths of sides of a lengthwise cross-section of the prism are respectively 45.5, 81, and 98.9 millimetres.

6. Oral measuring system according to claim 1, wherein the recording surface is at least as large as one of the sides of the set of teeth.

7. Oral measuring system according to claim 6, wherein a form of the prism is such that little or no reflections of contours of the picture surface are visible on the recording surface.

8. Oral measuring system according to claim 1, further comprising an anti-reflection coating on the picture surface and recording surface.

9. Oral measuring system according to claim 1, further comprising a protective plate in front of the recording surface, which is provided with an anti-reflection coating on both sides.

10. Oral measuring system according to claim 1, further comprising a removable protective cover, which is placed over the prism and protects at least a contact side, which protective cover is provided on both sides with an anti-reflection coating and/or has a provision on an outside to prevent condensation.

11. Oral measuring system according to claim 1, further comprising at least one optical mark on the recording surface of the interface.

12. Oral measuring system according to claim 1, characterized in that the interface on or near the recording surface is provided with at least one protrusion, which during use comes into contact with a part of at least one of the sides of the set of teeth to be measured or is inserted into at least one of the gaps between two neighbouring teeth.

13. Oral measuring system according to claim 12, characterized in that the interface comprises four Bauernfeind prisms, in which the recording surfaces are positioned with respect to each other so that one recording surface during use is against or near the occlusal side of the set of teeth to be measured, one recording surface is against or near the front of the set of teeth, and two recording surfaces are against or near the lateral sides of the set of teeth.

14. Oral measuring system according to claim 1, characterized in that at least one of the light-reflecting surfaces of the Bauernfeind prism is provided with a reflecting coating.

15. Oral measuring system according to claim 1, characterized in that the recording unit comprises a display.

16. Oral measuring system according to claim 1, wherein the recording unit comprises a white light source.

17. Oral measuring system according to claim 1, wherein the recording unit comprises a UV light source.

18. Oral measuring system according to claim 1, wherein the recording unit comprises an IR light source.

19. Oral measuring system according to claim 16, wherein the white light source is located opposite the prism.

20. An interface for use in an oral measuring system for taking a picture of a set of teeth or an oral cavity to be measured, the oral measuring system having a recording unit provided with a picture sensor, the interface comprising:
a light-conducting Bauernfeind prism adapted to be connected to the recording unit that is provided with a recording surface and a picture surface, which recording surface during use is brought into the vicinity of and/or in contact with one of the above sides of a set of teeth to be measured or into an oral cavity, and which picture surface is connected to the recording unit.
